(19) United States
(12) Patent Application Publication
(10) Pub. No.: US 2019/0232234 A1
(43) Pub. Date: Aug. 1, 2019

(54) Computerized Method and System for Enabling User Located Production of a Mixture of Substances

(71) Applicant: Flavour Message AG, Zug (CH)

(72) Inventor: Jörg Rychen, Zurich (CH)

(21) Appl. No.: 16/332,482

(22) PCT Filed: Aug. 31, 2017
(86) PCT No.: PCT/EP2017/071898

§ 371 Date: Mar. 12, 2019

(30) Foreign Application Priority Data
Sep. 13, 2016 (CH) 01188/16

(51) Int. Cl. B01F 3/00; G07F 13/06; G06F 16/901

(52) U.S. Cl. CPC B01F 3/0092; G06F 16/901; G07F 13/06

(57) ABSTRACT

The invention relates to user located production of a mixture of substances (3). Stored (S1) in a computer database (1) is assignment information (52) relating to a plurality of storage assemblies (51), each storage assembly comprising a plurality of storage elements, each storage element having stored a substance of a particular type, the assignment information (52) providing for each storage element an assignment of a property of the respective storage element to the substance stored in the respective storage element. Determined is first assignment information (52′) of a first storage assembly (51′) being arranged in a user located production device (2). Provided is a mixture definition (3′) defining the mixture of substances. Determined is production information based on the first assignment information (52′) and based on the mixture definition (3′), the production information including a definition of a subset of storage elements of the first storage assembly (51′), the production information enabling the production of the mixture of substances (3) with the user located production device (2).

### FIELD OF THE INVENTION

The present invention relates to a computerized method and system for enabling user located production of a mixture of substances. The invention further relates to a production facility that is configured to produce storage assemblies for enabling user located production of a mixture of substances. The invention further relates to a data processing equipment providing a computer database for enabling user located production of a mixture of substances.

### BACKGROUND

Presently, mixtures of substances, such as required for flavor products, perfumes, scents, food products, beverages, ingestible medicines, etc., are produced often in large quantities in production facilities in accordance to predefined quality requirements and in accordance to predetermined mixture definitions. In case of a flavor product, and in an analogous manner in case of other mixtures of substances, flavors can relate to, for example, strawberry, chocolate, mint, basil, etc. It is known that more than 1000 flavoring substances are active to the human olfactory and gustatory system. Most flavor products are composed of less than 30 flavoring substances out of a catalog of less than 300 flavoring substances.

In order to manufacture a particular flavor product, flavoring substances are arranged in the flavor product in accordance to a predefined flavor formula. The flavor formula defines amounts of one or more flavoring substances.

When producing a mixture of substances, different types of substances have to be mixed in accordance to a mixture definition. In production factories, quality requirements are strictly followed when producing mixtures of substances. Typically, in a production line for producing a mixture of substances, large volumes of the mixture of substances are produced. Accordingly, large quantities of the substances required for the production of a particular mixture of substances are arranged in the production factories along the production line. Production costs can therefore be kept low, while enabling high quality of the produced mixture of substances. A wide variety of mixtures of substances can be produced within the same production factory by adding further production lines or by adding further production factories.

A mixture of substances can be produced at a user location. At the user location, in order to have the possibility to produce a wide variety of different mixtures of substances, a large number of substances needs to be arranged in sufficiently large quantities. Typically, at the user location only small quantities of a mixture of a substance is required. Maintaining the substances used for the production of a mixture of substances at a user location is difficult, because rarely used substances may become out-of-date. Maintaining quality requirements at a user location is difficult, because the user may mix substances that are not or not well suited to be mixed. Typically, costs are relatively high when producing mixtures of substances at a user location.

### SUMMARY

It is an objective of this invention to provide a method and a system for user located production of a mixture of substances, which method and system do not have at least some disadvantages of the present state of the art. In particular, it is an objective of this invention to provide a method and a system for user located production of a mixture of substances that provide for controlled production of a mixture of substances at a user location. In particular, it is an objective of this invention to provide a method and a system for user located production of a mixture of substances that provide for monitored production of a mixture of substances at a user location. In particular, it is an objective of this invention to provide a method and a system for user located production of a mixture of substances that provide for production of a mixture of substances at a user location at high quality standards. In particular, it is an objective of this invention to provide a method and a system for user located production of a mixture of substances that provide for production of a mixture of substances at a user location at low costs.

According to the present invention, these objectives are achieved through the features of the independent claims. In addition, further advantageous embodiments follow from the dependent claims and the description.

According to the present invention, a computerized method for enabling user located production of a mixture of substances, comprises: storing in a computer database assignment information relating to a plurality of storage assemblies, each storage assembly comprising a plurality of storage elements, each storage element having stored a substance of a particular type, the assignment information providing for each storage element an assignment of a property of the respective storage element to the substance stored in the respective storage element, determining first assignment information of a first storage assembly being arranged in a user located production device, providing a mixture definition defining the mixture of substances, determining production information based on the first assignment information and based on the mixture definition, the production information including a definition of a subset of storage elements of the first storage assembly, the production information enabling the production of the mixture of substances with the user located production device. Thus, a provider can distribute storage assemblies to users and store in a computer database corresponding assignment information. For example, the assignment information can be stored in one or more data records. For example, each data record can have stored assignment information of a particular storage assembly. For a first storage assembly of these storage assemblies, a first assignment information can be stored. For example, the first assignment information can be stored in a first data record. A user can arrange the first storage assembly in a user located production device. In order to produce a mixture of substances in accordance to a mixture definition, access to the first assignment information stored in the computer database is required, which provides for each storage element an assignment of a property of the a storage element to the substance stored in the respective storage element. The production information is determined based on the mixture definition and the first assignment information. In order to control production of the mixture of substances, the provider can define under which circumstances access to the first assignment data is enabled. In order to monitor production of the mixture of substances, the provider can monitor access to the first assignment data. In order to maintain high quality standards, the provider can partly or fully block access to the first assignment information, for example to block production if a date of expiry of substances stored in the storage elements of the first storage assembly has lapsed, to block production on the basis of that do not match, etc. The method and system provide for a cheap production of mixture of substances, in particular because the storage assemblies can be designed that waste of substances is low.

In an embodiment, the method comprises: storing in the computer database assignment information relating to storage assemblies having stored the substances in the storage elements in a fashion that prevents that the stored substances can be identified by external visual inspection. Thus, in other words, without the assignment information, a storage assembly is useless for the users, and the provider of the storage assemblies can control and monitor production of mixtures of substances more precisely.

In an embodiment, the method comprises: storing in the computer database assignment information relating to storage assemblies which each comprise a set of storage elements having the same set of properties, wherein the storage elements of the storage assemblies have stored the substances in accordance to an individual permutation. The provider of the storage assemblies can chose individual permutations that are difficult to guess or determine and can therefore control and monitor production of mixtures of substances more precisely.

In an embodiment, the method comprises: storing in the computer database assignment information and configuring limited access to the assignment information stored in the computer database. Limiting access to the assignment information stored in the computer database can be enabled on the basis of user accounts, encryption algorithms, encryption keys, encrypted tokens, passwords, firewalls, routing information, etc. For example, access to the assignment information stored in the computer database can be enabled for the provider of the storage assemblies only. The provider can therefore control and monitor production of mixtures of substances more precisely.

In an embodiment, the method comprises: storing in the computer database assignment information relating to storage assemblies having more than ten storage elements. Without further information, it is practically impossible to guess or determine the substances stored in the storage elements. The provider can therefore control and monitor production of mixtures of substances more precisely.

In an embodiment, the method comprises: storing in the computer database assignment information relating to storage assemblies having included identification tags, wherein the assignment information is associated with the identification tags. In a variant, each storage assembly can have included an individual identification tag. The identification tag can simplify determining the first assignment information of a first storage assembly.

In an embodiment, the method comprises: storing in the computer database assignment information relating to storage assemblies having stored the respective substances in the storage elements in a manner that enables withdrawal of arbitrary amounts of the substances. For example, the substances can be stored in the storage elements in the form of a powder or grain, wherein an arbitrary amount defined by a weight or a volume of the powder or grain can be withdrawn for producing the mixture of substances.

In an embodiment, the method comprises: storing in the computer database assignment information relating to storage assemblies having stored the respective substances in the storage elements in a manner that enables withdrawal of preconfigured portions of the substances. For example, the substances can be stored in the storage elements in the form of globules or pellets, wherein by withdrawing a globule or a pellet, a predefined portion of the substance can be withdrawn.

In an embodiment, the method comprises: storing in the computer database assignment information relating to storage assemblies having properties of the storage elements that relate to one or more of: a relative position of a storage element within a storage assembly optionally together with an identification tag of the storage assembly; an externally identifiable code arranged on a storage element, such as a color code, a barcode; a physical property of a storage element, such as a dielectric property of the storage element, the frequency of an electromagnetic field enabling activation of a substance stored in a storage element. The storage elements can be arranged in accordance to rows and columns, wherein the property of a storage element is defined by its row and column, optionally further defined by the identification tag of the storage assembly. The storage element can include an externally identifiable code, such as a color code, barcode, etc., which can enable identification of the storage element and together with the assignment information the substance stored in the storage element. A physical property of the storage element such as a dielectric property can enable identification of the storage element and together with the assignment information the substance stored in the storage element. The storage element can have the form of microcapsules which store particular substances and which can be activated by an external electromagnetic field of a particular frequency. Thus, the frequency can enable selection of storage elements and together with the assignment information the activation of substances stored in the storage elements.

In an embodiment, the method comprises: storing in the computer database assignment information relating to one or more of: an assignment function, and assignment data. The assignment function can provide an assignment in a form that uses little computer memory. The assignment data can provide an assignment in a form that can enable arbitrary assignments.

In an embodiment, the method comprises: determining production information that includes an amount pattern, each element of the amount pattern defining a storage element of the first storage assembly and the respective amount of the substance required from that storage element for producing the mixture of substances. The production information can have the form of a data array corresponding to storage elements arranged in row and columns, wherein each element of the data array defines an amount such as a weight or a volume of the respective substance that needs to be withdrawn in order to produce the mixture of substances.

In an embodiment, the method comprises: determining production information that includes a bit pattern, each element of the bit pattern defining if a predefined portion of the substance stored in the respective storage element is required for producing the mixture of substances. The production information can have the form of a data array corresponding to storage elements arranged in row and columns, wherein each element of the data array is a bit having the value 0 or 1 and defining if a predefined portion stored in a storage element needs to be withdrawn in order to produce the mixture of substances.

In an embodiment, the method comprises: providing the mixture definition by analyzing control actions of a user manipulating a user interface of a user device. The user can create a mixture definition, can select a predefined mixture definition stored in a local or remote database, amend a predefined mixture definition, etc.

In an embodiment, the method comprises: making available the provided mixture definition on a computing device having access to the computer database. The computing device can be included in the user located production device, a user device, a data processing equipment providing the computer database, etc. Access to the computer database can include secured communication channels.

In an embodiment, the method comprises at least one of: providing a mixture definition that includes encrypted definition data and decrypting the encrypted definition data; and providing a mixture definition that includes at least a subset of a uniform resource identifier relating to the mixture definition and using the at least subset of the uniform resource identifier. Accordingly, access to the mixture definition can be restricted. A mixture definition may be the result of a large number of tests with various mixture definitions.

In an embodiment, the method comprises: sending a device query to the user located production device and transmitting from the user located production device to the sender of the device query storage assembly information related to the first storage assembly, the storage assembly information enabling determining the first assignment information of the first storage assembly. For example, the first storage assembly may include an identification tag, wherein information about the identification tag can be queried in order to enable that the first assignment information of the first storage assembly can be identified.

In an embodiment, the method comprises: providing a mixture definition that specifies amounts of a plurality substances of the mixture of substances. The amounts can be defined as relative amounts. The amounts can relate to a weight, a volume, etc.

In an embodiment, the method comprises: providing a mixture definition that specifies one or more of: a flavor product, a perfume, a scent, a food product, a stimulant, a beverage, a functional food product, a plant medicine, a phytological product. Mixture of substances can be produced for a wide variety of applications.

In an embodiment, the method comprises: determining information about a user being associated with the production of the mixture of substances and requesting feedback from that user. User feedback can enable improving quality, security, etc.

In an embodiment, the method comprises: storing in a mixture database a plurality of unique identifiers each identifying at least a part of a mixture definition. A unique identifier can include a serial number, a name, a uniform resource identifier, etc. The mixture database can have restricted access as regards reading or writing of data.

The invention further relates to a system for enabling user located production of a mixture of substances. The system comprises: a computer database having stored assignment information relating to a plurality of storage assemblies, each storage assembly comprising a plurality of storage elements, each storage element having stored a substance of a particular type, the assignment information providing for each storage element an assignment of a property of the respective storage element to the substance stored in the respective storage element, a user located production device having arranged a first storage assembly relating to first assignment information, a user interface enabling a user to provide a mixture definition defining the mixture of substances, a computing unit for determining production information based on the first assignment information and based on the mixture definition, the production information including a definition of a subset of storage elements of the first storage assembly, the production information enabling the production of the mixture of substances with the user located production device.

In an embodiment, the system comprises a data processing equipment providing one or more of: the computer database, the computing unit, and the user interface.

In an embodiment, the system comprises a user device providing one or more of: the computing unit, and the user interface.

In an embodiment of the system, the computing unit and/or the user interface are provided by the user located production device.

In an embodiment, the system comprises a production facility enabling production of storage assemblies in accordance to corresponding assignment information.

In an embodiment, the system is at least partially connected to the Internet for enabling transmission and/or receipt of electronic information.

The invention further relates to a production facility that is configured to produce storage assemblies for enabling user located production of a mixture of substances, each storage assembly being produced in accordance to corresponding assignment information, each storage assembly comprising a plurality of storage elements, each storage element having stored a substance of a particular type, the assignment information providing for each storage element an assignment of a property of the respective storage element to the substance stored in the respective storage element.

In an embodiment, the production facility is enabled to produce storage assemblies having stored the substances in the storage elements in a fashion that prevents that the stored substances can be identified by external visual inspection.

In an embodiment, the production facility is enabled to produce storage assemblies which each comprise a set of storage elements having the same set of properties, wherein the storage elements of the storage assemblies have stored the substances in accordance to an individual permutation.

The invention further relates to a data processing equipment providing a computer database for enabling user located production of a mixture of substances, the computer database having stored assignment information relating to a plurality of storage assemblies, each storage assembly comprising a plurality of storage elements, each storage element having stored a substance of a particular type, the assignment information providing for each storage element an assignment of a property of the respective storage element to the substance stored in the respective storage element.

In an embodiment of the data processing equipment, the computer database has stored assignment information relating to storage assemblies having stored the substances in the storage elements in a fashion that prevents that the stored substances can be identified by external visual inspection.

In an embodiment of the data processing equipment, the computer database has stored assignment information relating to storage assemblies which each comprise a set of storage elements having the same set of properties, wherein the storage elements of the storage assemblies have stored the substances in accordance to an individual permutation.

In an embodiment, the data processing equipment is configured with limited access to the assignment information stored in the computer database.

### BRIEF DESCRIPTION OF THE DRAWINGS

In order to describe the manner in which advantages and features of the disclosure can be obtained, in the following a more particular description of the principles briefly described above will be rendered by reference to specific embodiments thereof which are illustrated in the appended drawings. These drawings depict only exemplary embodiments of the disclosure and are not therefore to be considered to be limiting of its scope. The principles of the disclosure are described and explained with additional specificity and detail through the use of the accompanying drawings in which:

FIG. 1 illustrates schematically a computerized method and a system for enabling user located production of a mixture of substances;

FIG. 2 illustrates schematically a first storage assembly;

FIG. 3 illustrates schematically a first assignment information of the first storage assembly;

FIG. 4 illustrates schematically a first possible scenario for the production of a mixture of substances;

FIG. 5 illustrates schematically a second possible scenario for the production of a mixture of substances; and

FIG. 6 illustrates schematically a mixture definition in the form of a mixture data structure.

### DESCRIPTION

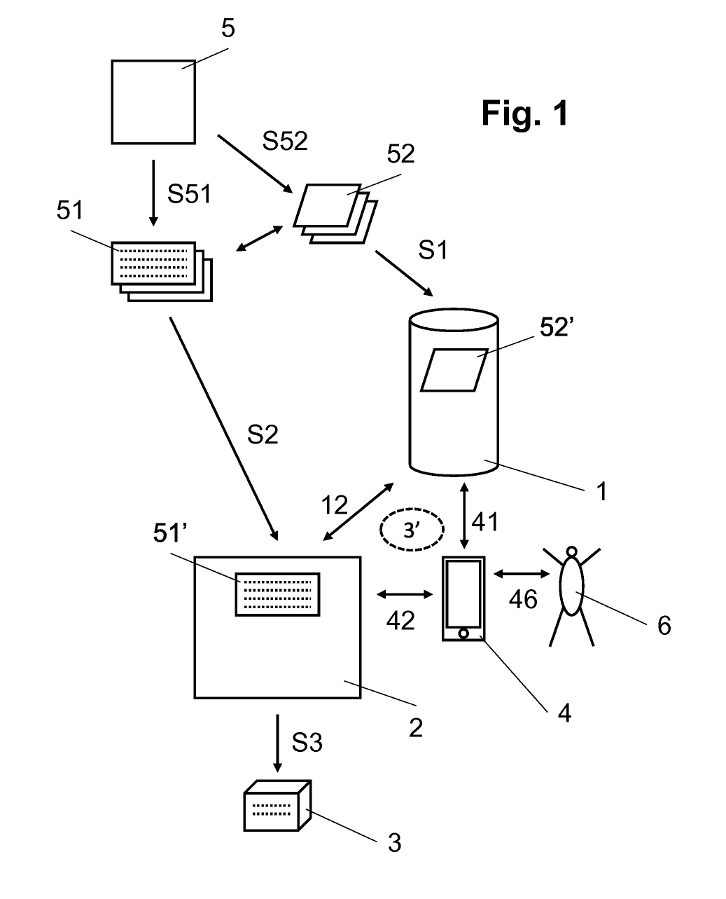

FIG. 1 illustrates schematically a computerized method and a system for enabling user located production of a mixture of substances 3. In step S1, assignment information 52 is stored in a computer database 1. The assignment information 52 relates to a plurality of storage assemblies 51, which each comprise a plurality of storage elements, wherein each storage element has stored a substance of a particular type. The assignment information 52 provides for each storage element an assignment of a property of the respective storage element to the substance stored in the respective storage element.

A data processing equipment can provide the computer database 1. The data processing equipment can relate to a server computer, to a cloud computer, to a virtual computer, etc.

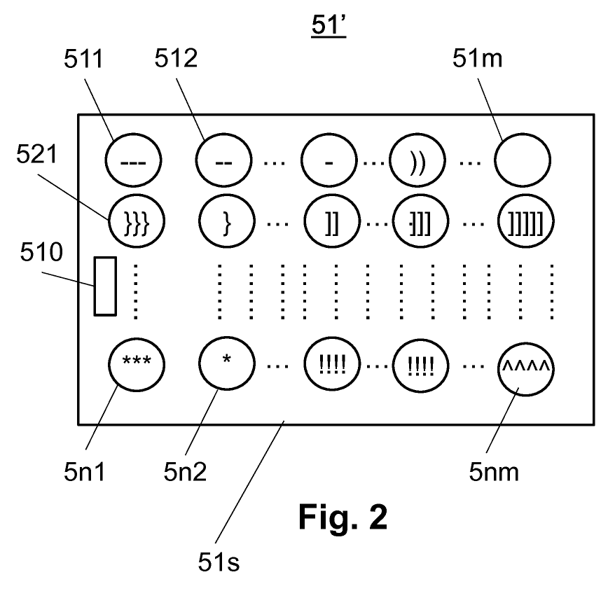

FIG. 2 illustrates schematically a first storage assembly 51′ of the plurality of storage assemblies 51. The first storage assembly 51′ comprises a rectangular support 51s for supporting a plurality of storage elements 511, 512, . . . 51m, 521, 522, . . . , 52m, . . . , 5n1, 5n2, . . . , 5mn. For the sake of clarity, in FIG. 2 not all reference signs of the storage elements are illustrated. Each storage element has stored a substance of a particular type, which is illustrated in FIG. 2 using different symbols, such as - - - , - -, . . . ,}}}, . . . , * * *, etc. The stored substances can relate to any substance that is suitable for producing a mixture of substances. The storage elements have stored the substances in a fashion that prevents that the stored substances can be identified by external visual inspection. Therefore, a user having in the hands the first storage assembly 51′ cannot identify which substances are stored in the storage elements. As illustrated in FIG. 2, the first storage assembly 51′ includes an identification tag 510, such as a barcode, a colorcode, an RFID-tag, etc. The storage elements of the first storage assembly 51′ can be identified by their relative position. For example, the storage assembly with reference sign 511 is arranged on the top left position of the first storage assembly 51′, the storage assembly with reference sign 512 is arranged to the right of the storage assembly with reference sign 511, the storage assembly with reference sign 521 is arranged below the storage assembly with reference sign 511, etc.

In the example according to FIG. 2, the property of a storage element is defined by the relative position. The property of a storage element can be defined in other ways.

The substances can be stored in the storage elements of the storage assemblies 51 in various ways. In a variant, a substance can be stored in a storage element in such a way that—up to a predefined maximum amount—an arbitrary amount of the substance can be withdrawn from the storage element. In a variant, a substance can be stored in a storage element in one or more preconfigured portions, wherein one or more portions can be withdrawn from the storage element at a time. In a variant, a substance can be stored in a storage element diluted in a liquid, wherein single drops or a predefined liquid stream can be withdrawn from the storage element. The substances can be stored in the storage elements in other ways.

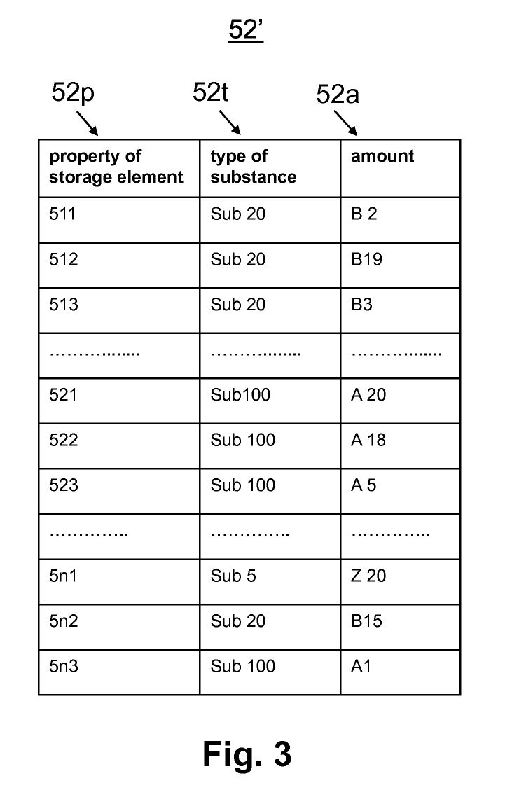

FIG. 3 illustrates schematically a first assignment information 52′ of the first storage assembly 51′, which is comprised in the assignment information 52 of the storage assemblies 51. The first assignment information 52′ includes a data table having three columns 52p, 52t, 52a. The first column 52p denotes a property of the storage element, for example the relative position of the storage element with respect to the first storage assembly 51′. The second column 52t denotes the type of the substance that is stored in the respective storage element. The third column 52a relates to the amount of the substance that is stored in the respective storage element.

The assignment information 52 of the storage assemblies 51 can comprise an assignment function and/or to assignment data. The case of assignment data is described above in connection with FIG. 3. An assignment function can provide a mapping from a property of a storage element, such as the relative position of the storage element in the storage assembly, to the type of the substance that is stored in the respective storage element. Additionally, the assignment function can define the amount or a preconfigured portion of a substance that can be withdrawn from the respective storage element.

As illustrated in FIG. 1, a production facility 5 can be arranged that is enabled to produce storage assemblies 51 in accordance to assignment information 52. The assignment information 52 can be defined in various ways. The storage assemblies 51 are distributed through various distribution channels, such as city stores, online stores, etc., to users. The assignment information 52 is stored in the computer database 1. Without the assignment information 52, the storages assemblies 51 are useless to the users.

As illustrated in FIG. 1, the storage assemblies 51, the first storage assembly 51′ and the mixture of substances 3 include a matrix of dots. These dots represent substances, which are stored in storage elements in case of the storage assemblies 51 and the first storage assembly 51′, or which are arranged in the mixture of substance 3.

As illustrated in FIG. 1, the first storage assembly 51′ is arranged in a user located production device 2. In step S2, the user has for example purchased the first storage assembly 51′ in a store and has installed the first storage assembly 51′ in the user located production device 2. The user located production device 2 is designed to withdraw substances stored in the storage elements of the first storage assembly 51′ in order to produce the mixture of substances 3. The user located production device 2 includes controllable appliances that enable withdrawl of arbitrary amounts and/or preconfigured portions from the first storage assembly 51′. The first assignment information 52′ relating to the first storage assembly 51′ is stored in the computer database 1. For example, an identification tag of the first storage assembly 51′ can enable that the first assignment data 52′ stored in the computer database 1 can be determined, the first assignment data 52′ being related to the first storage assembly 51′.

As illustrated in FIG. 1, a mixture definition 3′ defining the mixture of substances is provided. The mixture definition 3′ specifies or defines an amount of a plurality of substances of the mixture of substances 3.

The mixture definition 3′ can be provided in various ways. In order to provide the mixture definition 3′, a user device 4, the user located production device 2, the computer database 1, etc. can be involved. The user device 4 can relate to a smartphone, a laptop computer, a desktop computer, etc. As illustrated in FIG. 1, interactions 12, 41, 42, 46 between various devices as well as between various devices and a user 6 can be involved for providing the mixture definition 3′. The interaction with reference sign 12 relates to the interaction between the user located production device 2 and the computer database 1. The interaction with reference sign 42 relates to the interaction between the user located production device 2 and the user device 4. The interaction with reference sign 41 relates to the interaction between the user device 4 and the computer database 1. The interaction with reference sign 46 relates to the interaction between the user device 4 and the user 6. The interactions with reference signs 12, 42, 41 can involve network interfaces for communication such as over the Internet, over Bluetooth, etc. The interaction with reference sign 46 can involve a user interface such as a graphical user interface.

In a variant, the user 6 can manipulate the user device 4 in order to provide the mixture definition 3′ by selecting a mixture definition stored in the user device 4. In a variant, the user 6 can manipulate the user located production device 2 in order to provide the mixture definition 3′ by selecting a mixture definition stored in the user located production device 2. In a variant, the user 6 can manipulate the user device 4 in order to provide a mixture definition 3′ by selecting a mixture definition stored in the data processing equipment providing the computer database 1. In a variant, the user 6 can manipulate the user device 4 in order to provide a mixture definition 3′ by selecting a mixture definition stored in the computer database 1. The mixture definition 3′ can be provided in other ways.

In order to enable production of the mixture of substances 3 with the user located production device 2, production information is determined based on the first assignment information 52′ and based on the mixture definition 3′. The mixture definition 3′ includes amounts of substances required for the production of the mixture of substances 3. The production information includes a definition of a subset of storage elements of the first storage assembly 51′. The definition of the subset of storage elements can include properties of the respective storage elements, such as the relative position of the respective storage elements. By withdrawing required amounts of substances—in accordance to the mixture definition 3′—from the subset of storage elements of the first storage assembly 51′, the mixture of substance 3 can be produced.

The production information can be determined in various ways. In a variant, the mixture definition 3′ is transmitted to the data processing equipment providing the computer database 1, such that a computing unit of the data processing equipment can determine the production information based on the mixture definition 3′ and the first assignment information 52′. In a variant, the mixture definition 3′ and the first assignment information 52′ are transmitted to the user device 4, such that a computing unit of the user device 4 can determine the production information based on the mixture definition 3′ and the first assignment information 52′. In a variant, the mixture definition 3′ and the first assignment information 52′ are transmitted to the user located production device 2, such that a computing unit of the user located production device 4 can determine the production information based on the mixture definition 3′ and the first assignment information 52′.

Access to the assignment information 52 stored in the computer database 1 can be limited. In a variant, access is limited to the data processing equipment providing the computer database 1, for example using appropriate accounts and configuration of the data processing equipment. In a variant, encrypted communication between the user located production device 2 and the computer database 1 enables limited access to the assignment information 52 stored in the computer database 1. In a variant, encrypted communication between the user device 4 and the computer database 1 enables limited access to the assignment information 52 stored in the computer database 1. Access to the assignment information 52 stored in the computer database 1 can be limited in other ways.

In case the storage assemblies 51 have more than ten storage elements, the probability is already very low that a user can guess or determine by chance the substances that are stored in the storage elements.

Each one of a set of storage assemblies can include an identification tag. When a first storage assembly 51′ of such a set of storage assemblies is installed in the user located production device 2, the identification tag enables to determine the first assignment data 52′ related to the first storage assembly. Each one of the set of the storage assemblies can include storage elements with different properties having stored different types of substances.

Each one of a set of storage assemblies can include storage elements having the same set of properties, wherein for each one of a set of storage assemblies, different types of substances are arranged in the storage elements. Wherein for each one of the set of storage assemblies the storage elements have the same properties, corresponding storage elements of different storage assemblies have stored different types of substances.

The substances can be stored in the storage elements in a manner that enables withdrawl of arbitrary amounts up to a maximum of the substances. For example, the storage elements can have stored the substances in the form of a powder or liquid, wherein appliances such as flaps, valves, etc. of the user located production device 2 enable withdrawl of arbitrary amounts of the substances, such as an arbitrary volume, weight, etc.

The substances can be stored in the storage elements in a manner that enables withdrawl of preconfigured portions of the substances. For example, the storage elements can have stored the substances in the form of globules, bullets, etc., wherein appliances such as flaps enable withdrawl of one or more globules, bullets, etc. at a time from the storage elements.

The property of a particular storage element, which enables in connection with the assignment information to determine the substance that is stored in the storage element, can relate to a relative position of the storage element with respect to the storage assembly, such as the row and column as illustrated in FIG. 2. The property of a storage element can relate to an externally identifiable code such as a color code, a barcode. The property of a storage element can relate to a physical property such as a dielectric property, the frequency of an electromagnetic field enabling activation of a substance store in the storage element. For example, the storage element can have the form of a microcapsule that can be activated using an electromagnetic field of a particular frequency.

The production information can include an amount pattern. Each element of the amount pattern can define a storage element, which can be identified by a property of the storage element, and an amount of the substance that is to be withdrawn from that storage element for producing the mixture of substances 3. The amount pattern can relate to a data array, each element of the data array defining a volume, a weight, etc. of a particular storage element of the storage assembly.

The production information can include a bit pattern. Each element of the bit pattern can define if a predefined portion of the substance stored in the respective storage element is required for producing the mixture of substances 3. The bit pattern can relate to a data array, each element of the data array defining if a particular storage element of the storage assembly.

The mixture definition 3′ can include unencrypted and/or encrypted definition data. In case of encrypted definition data, respective keys can be stored—for example—in the data processing equipment providing the computer database 1. The mixture definition 3′ can include at least a subset of a uniform resource identifier relating to the mixture definition. The uniform resource identifier can relate to a resource of the data processing equipment providing the computer database 1. When using the at least subset of the uniform resource identifier, the respective mixture definition 3′ is provided.

The first assignment information 52′ can be determined in a push fashion or in a pull fashion. In a push fashion, upon arranging the first storage assembly 51′ in the user located production device 2, the assignment information 52′ can be determined by pushing data such as data of an identifier tag of the first storage assembly 51′ to a respective device, such as the data processing equipment providing the computer database 1, wherein by lookup of stored assignment information 52 in the computer database 1, such as on the basis of data of the identifier tag, the first assignment information 52′ is determined. In a pull fashion, a device query is transmitted to the user located production device 2. For example, if a computing unit of the data processing equipment providing the computer database 1 is about to determine the production information on the basis of a provided mixture definition 3′, the first assignment information 52′ of the first storage assembly 51′ arranged in the user located production device 2 is determined by sending form the data processing equipment to the user located production 2 a device query. Upon receipt of the device query, the user located production 2 determines data about the first storage assembly 51′, such as data of an identifier tag of the first storage assembly 51′. The determined data is sent to the data processing equipment, which uses the received data in order to determine the first assignment data 52′. The first assignment data 52′ is then used, together with the mixture definition 3′, for determining the production information.

The mixture definition 3′ can relate to a flavor product, a perfume, a scent, a food product, a stimulant, a beverage, a functional food product, a plant medicine, and/or a phytological product. The mixture definition 3′ can relate to other products.

The data processing equipment providing the computer database 1 can determine information about the user of the user located production device 2. For example, the data processing equipment can have stored an e-mail address of the user of the user located production device 2 and can request by e-mail feedback from the user. The feedback can include a response of the user to a questionnaire, which can relate to production speed, ease of use, quality of the produced mixture of substances 3, etc.

Mixture definitions can be stored in a mixture database. The mixture database can include a plurality of unique identifiers each identifying at least a part of a mixture definition.

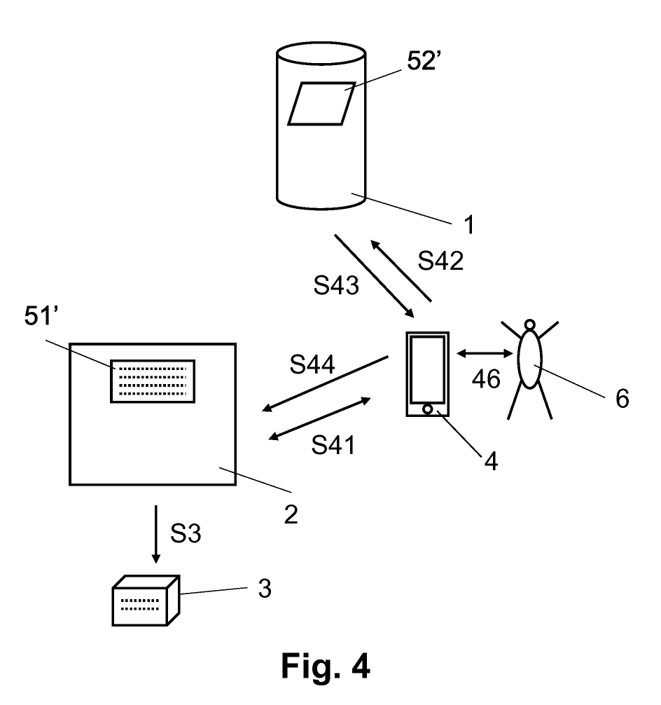

FIG. 4 illustrates schematically a first possible scenario for the production of a mixture of substances 3, which involves a user located production device 2, a user device 4 and a computer database 1. A user 6 manipulates a user interface of the user device 4 and controls the steps for producing the mixture of substances 3. In step S41, the user located production device 2 is requested to transmit data related to an identification tag of a first storage assembly 51′ that is arranged in the user located production device 2. The data related to the identification tag of the first storage assembly 51′ is transmitted to the user device 4. For example, a NFC (Near Field Communication) channel is established between the user located production device 2 and the user device 4. Any other communication can be established. In step S42, the data related to the identification tag of the first storage assembly 51′ is transmitted to the data processing equipment providing the computer database 1. Moreover, in step S42 a mixture definition 3′ selected by the user 6 is transmitted to the data processing equipment providing the computer database 1. A computing unit of the data processing equipment providing the computer database 1 determines on the basis of the data related to the identification tag of the first storage assembly 51′ the first assignment information 52′ related to the first storage assembly 51′. Moreover, the computing unit of the data processing equipment providing the computer database 1 determines, on the basis of the mixture definition 3′ and the first assignment information 52′, production information enabling production of the mixture of substances 3 with the user located production device 2. In step S43, the data processing equipment providing the computer database 1 transmits the production information to the user device 4. In steps S42, S43, data can be transmitted through a mobile communications network such as GSM, 3G, LTE, etc. The production information can be verified by the user on the user device 4. In step S44, the production information is transmitted to the user located production device 2. Upon receipt of the production information, the user located production device produces in step S3 the mixture of substances 3.

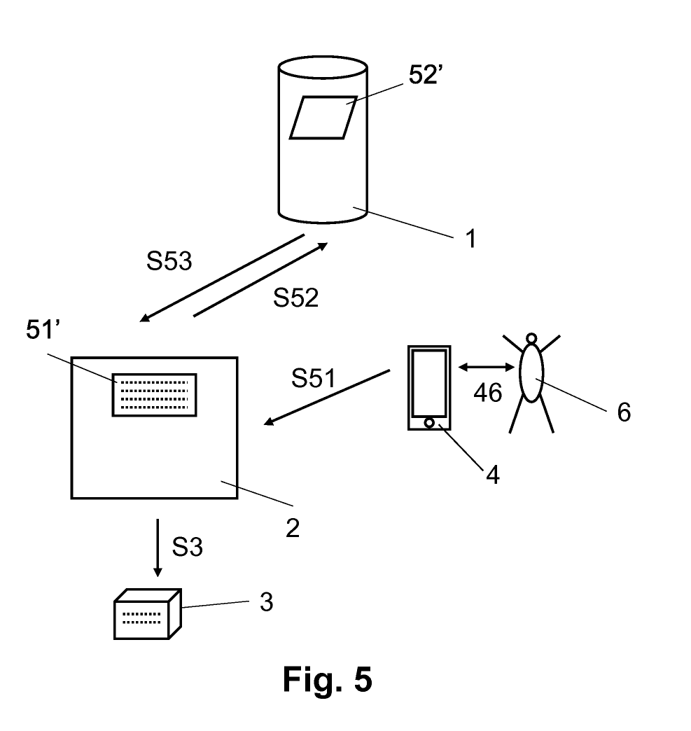

FIG. 5 illustrates schematically a second possible scenario for the production of a mixture of substances 3, which involves a user located production device 2, a user device 4 and a computer database 1. A user 6 manipulates a user interface of the user device 4 and controls the steps for producing the mixture of substances 3. In step S51, a mixture definition 3′, which the user 6 has selected on the user device 4, is transmitted from the user device 4 to the user located production device 2. For example, a NFC (Near Field Communication) channel is established between the user located production device 2 and the user device 4. Any other communication can be established. In step S52, the mixture definition 3′ is transmitted together with data related to an identification tag of a first storage assembly 51′ that is arranged in the user located production device 2 to the data processing equipment providing the computer database 1. A computing unit of the data processing equipment providing the computer database 1 determines on the basis of the data related to the identification tag of the first storage assembly 51′ the first assignment information 52′ related to the first storage assembly 51′. Moreover, the computing unit of the data processing equipment providing the computer database 1 determines, on the basis of the mixture definition 3′ and the first assignment information 52′, production information enabling production of the mixture of substances 3 with the user located production device 2. In step S53, the production information is transmitted to the user located production device 2. In steps S42, S43, data can be transmitted through a communications network such as the Internet, etc. Upon receipt of the production information, the user located production device produces in step S3 the mixture of substances 3.

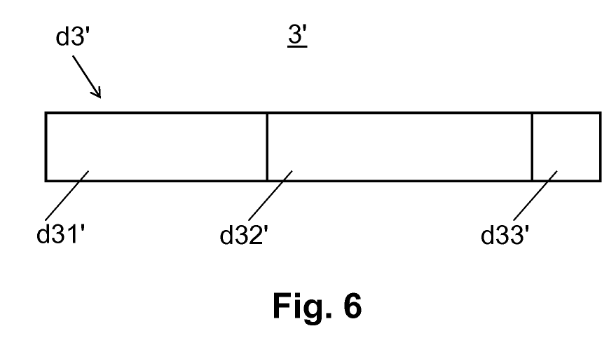

FIG. 6 illustrates schematically a mixture definition 3′ in the form of a mixture data structure d3′. The mixture data structure d3′ can be designed for transmission via a telecommunication network comprising wired and/or wireless telecommunication links. For example, the mixture data structure d3′ can be designed for transmission via a TCP/IP data stream (TCP: Transmission Control Protocol) of an IP Network (IP: Internet Protocol), via an SMS message (SMS: Short Message Service), via electronic mail, etc.

As schematically illustrated in FIG. 6, the mixture data structure d3′ can comprise a plain storage part d31′. The mixture data structure d3′ can further comprise an encrypted storage part d32′ for storing encrypted data. The mixture data structure d3′ can further comprise a signature storage part d33′ for storing a digital signature.

The plain data stored in the plain storage part d31′ can include a unique identifier for uniquely identifying the mixture data structure d3′. The plain data stored in the plain storage part d31′ can include a name, a color, an index, at least a part of an URI, etc. for defining a mixture of substances 3. The plain data stored in the plain storage part d31′ can include a composer, an owner, etc. for identification of a person having composed, owning, etc. a mixture of substances 3. The plain data stored in the plain storage part d31′ can include a creation date for identification of the date of creation, composition, etc. of a mixture of substances 3. The plain data stored in the plain storage part d31′ can include a ring tone, a tweet, a hyperlink, a hash tag, etc. for providing further information about a mixture of substances 3, such as acoustical information, a detailed description, the idea behind a creation, etc. The plain data stored in the plain storage part d31′ can include a reference to one or more mixture data structures for identification of a combination of further mixtures of substances the present mixture of substances is based on.

The encrypted data stored in the encrypted storage part d32′ can include one or more encrypted mixture definitions, wherein for example the data processing equipment providing the computer database 1 can be configured to control permission to encrypt and/or decrypt encrypted data. For example, a respective encryption key is stored in the computer database 1.

The digital signature stored in the signature storage part d33′ can include signature data based on a private key/public key algorithm, wherein, for example, the private key is stored on the computer database 1. The digital signature can relate to data stored in the plain data part d31′ and/or to data stored in the encrypted data part d32′.

1. A computerized method for enabling user located production of a mixture of substances, comprising:
storing, in a computer database, assignment information relating to a plurality of storage assemblies, each storage assembly comprising a plurality of storage elements, each storage element storing a substance of a particular type, wherein the assignment information for each storage element of the plurality of storage elements comprises an assignment of a property of the respective storage element to the substance stored within the respective storage element;
determining a first assignment information of a first storage assembly arranged in a user located production device;
providing a mixture definition, which defines a the mixture of substances,
determining production information based on the first assignment information and the mixture definition, wherein the production information includes a definition of a subset of storage elements of the first storage assembly, and is configured to enable the production of the mixture of substances with the user located production device.

2. The method according to claim 1, further comprising: storing, in the computer database, assignment information relating to storage assemblies, the storage assemblies being configured to prevent the identification of the substances stored therein by external visual inspection.

3. The method according to claim 1, further comprising: storing, in the computer database, assignment information relating to storage assemblies comprising a set of storage elements having the same set of properties, wherein the storage elements of the storage assemblies store the substances in accordance with an individual permutation.

4. The method according to claim 1, further comprising: storing, in the computer database, assignment information and configuring limited access to the assignment information stored in the computer database.

5. (canceled)

6. The method according to claim 1, further comprising: storing, in the computer database, assignment information relating to storage assemblies comprising identification tags, wherein the assignment information is associated with the identification tags.

7. (canceled)

8. (canceled)

9. The method according to claim 1, further comprising:
storing, in the computer database, assignment information relating to storage assemblies comprising properties of the storage elements, of the properties comprising at least one of: a relative position of the storage element within the storage assembly; an identification tag of the storage assembly; an externally identifiable code arranged on the storage element; or a physical property of a storage element.

10. (canceled)

11. The method according to claim 1, comprising: determining production information comprising either:
a) an amount pattern comprising elements, each element of the amount pattern defining a storage element of the first storage assembly and a respective amount of the substance required from that storage element to produce the mixture of substances; or
b) a bit pattern comprising elements, each element of the bit pattern defining whether a predefined portion of the substance stored in the respective storage element is required for producing the mixture of substances.

12. (canceled)

13. The method according to claim 1, comprising: providing the mixture definition by analyzing control actions of a user manipulating a user interface of a user device.

14. (canceled)

15. The method according to claim 1, further comprising at least one of:
providing a mixture definition that includes encrypted definition data and decrypting the encrypted definition data; or
providing a mixture definition that includes at least a subset of a uniform resource identifier relating to the mixture definition and using the at least subset of the uniform resource identifier.

16. The method according to claim 1, further comprising:
sending a device query to the user located production device; and
transmitting from the user located production device to a sender of the device query storage assembly information related to the first storage assembly, wherein the storage assembly information enables a determination of the first assignment information of the first storage assembly.

17. (canceled)

18. (canceled)

19. The method according to claim 1, further comprising:
determining information about a user associated with the production of the mixture of substances and requesting feedback from that user.

20. (canceled)

21. A system for enabling user located production of a mixture of substances, comprising:
a computer database having stored assignment information relating to a plurality of storage assemblies, each storage assembly comprising a plurality of storage elements, each storage element storing a substance of a particular type, wherein the assignment information for each storage element of the plurality of storage elements comprises an assignment of a property of the respective storage element to the substance stored within the respective storage element,
a user located production device configured to arrange a first storage assembly related to first assignment information,
a user interface configured to enable a user to provide a mixture definition, defining a mixture of substances,
a computing unit for determining production information based on the first assignment information and the mixture definition, wherein the production information comprises a definition of a subset of storage elements of the first storage assembly and is configured to enable the production of the mixture of substances with the user located production device.

22. (canceled)

23. (canceled)

24. The system according to claim 21, wherein one or more of the computing unit or the user interface are provided by the user located production device.

25. The system according to claim 21, further comprising a production facility configured to enable the production of storage assemblies in accordance with corresponding assignment information.

26. (canceled)

27. A production facility configured to produce storage assemblies for user located production of a mixture of substances, wherein each storage assembly is produced in accordance with corresponding assignment information, each storage assembly comprising a plurality of storage elements, each storage element being configured to store a substance of a particular type, wherein the corresponding assignment information for each storage element comprises an assignment of a property of the respective storage element to the substance stored in the respective storage element, wherein the production facility is configured to produce storage assemblies having stored therein substances in the storage elements such that the stored substances cannot be identified by external visual inspection.

28.-33. (canceled)

34. The method according to claim 9, wherein the externally identifiable code comprises at least one of a color code or a barcode.

35. The method according to claim 9, wherein the physical property of the storage element comprises at least one of a dielectric property of the storage element or a frequency of an electromagnetic field enabling activation of a substance stored in the storage element.
